(19) United States
(12) Patent Application Publication
(10) Pub. No.: US 2026/0084640 A1
(43) Pub. Date: Mar. 26, 2026

(54) MAGNETIC REPULSION SYSTEMS AND METHODS FOR MITIGATING VEHICLE COLLISIONS

(71) Applicant: Brenda S. McMann, Newport, WA (US)

(72) Inventor: Brenda S. McMann, Newport, WA (US)

(21) Appl. No.: 19/340,570

(22) Filed: Sep. 25, 2025

Related U.S. Application Data
(60) Provisional application No. 63/699,104, filed on Sep. 25, 2024.

(51) Int. Cl. B60R 19/18

(52) U.S. Cl. CPC B60R 19/18; B60R 2019/1893; B60Y 2400/404

(57) ABSTRACT

The present technology is generally directed to a magnetic repulsion system configured to reduce or mitigate the severity of an inadvertent collision between two or more vehicles. For example, the anti-collision systems disclosed herein comprise a plurality of magnetic bars carried by a vehicle. The magnetic bars have a particular polarity and, upon inadvertent contact between the vehicle and another vehicle having magnetic bars with a different polarity, the bars will repel each other, thereby inhibiting/reducing the severity of impact during an inadvertent collision between the two vehicles.

### CROSS-REFERENCE TO RELATED APPLICATION

This application claims the benefit of and priority to U.S. Provisional Patent Application No. 63/699,104, filed Sep. 25, 2024, and which is incorporated herein by reference in its entirety.

### TECHNICAL FIELD

The present technology generally relates to anti-collision systems and methods and, in particular, to magnetic repulsion systems carried by moving vehicles with features for reducing or mitigating the severity of an inadvertent collision between two or more vehicles.

### BACKGROUND

For years, the automotive industry has been developing active collision prevention systems and techniques to detect the surrounding conditions of a vehicle. Such systems can be utilized by vehicles to maintain a safe distance from other vehicle(s) that have suddenly stopped or decelerated, or to use automatic steering and/or braking to avoid other obstacles—thus resulting in the active protection of the driver and passenger(s). Conventional methods for mitigating the active collision of a moving vehicle include automatically decelerating the vehicle when a front vehicle is in a detection range of a sensor of the vehicle, so as to maintain a safe distance from the front vehicle, and returning to a preset speed when the front car is out of the detection range. Other conventional methods include automatically controlling the brake and the accelerator when the possibility of a collision is detected. These conventional methods, however, fail to accommodate all driving situations, such as when there is a malfunction or the safe distance between two vehicles is compromised, resulting in a collision. Therefore, there is a need for a magnetic repulsion system, generating magnetic force and using repulsive magnetic forces to mitigate a collision with a nearby object.

### BRIEF DESCRIPTION OF THE DRAWINGS

Many aspects of the present technology can be better understood with reference to the following drawings. The components in the drawings are not necessarily drawn to scale. Instead, emphasis is placed on illustrating clearly the principles of the present technology. Furthermore, components can be shown as transparent in certain views for clarity of illustration only and not to indicate that the component is necessarily transparent. Components may also be shown schematically.

FIG. 1A-1E are top and lateral side views of a vehicle including a magnetic repulsion system configured in accordance with an embodiment of the present technology.

FIG. 2-4 are top views of two objects including magnetic repulsion systems configured in accordance with embodiments of the present technology and adapted to reduce/inhibit the severity of a collision between the objects.

FIG. 5A-5E are top and lateral side views of a vehicle including a magnetic repulsion system with a plurality of magnetic bars coupled to non-exposed interior surfaces of the vehicle and configured in accordance with an embodiment of the present technology.

### DETAILED DESCRIPTION

The present technology is generally directed to vehicles having features designed to inhibit or reduce the severity of a collision with other vehicles and associated systems and methods. Anti-collision mechanisms are commonly used to promote safer roads for drivers and their passengers by controlling the speed of a vehicle when it is too close to a surrounding vehicle, or automatically controlling the brake when a near collision is sensed. As described throughout this Detailed Description, magnetic repulsion systems configured in accordance with the present technology can have various magnetic features that are expected to reduce or mitigate the severity of a collision between two or more vehicles. For example, in many embodiments described herein, the anti-collision systems include one or more anti-collision features through the use of a plurality of magnetic bars (e.g., electromagnets) coupled to the surface of or otherwise carried by a vehicle. The magnetic bars have a particular polarity and, when they are proximate to magnetic bars having a different polarity, the bars will repel each other, thereby inhibiting/reducing the severity of impact during a collision. The anti-collision systems described herein can also include sensors and/or accelerometers integrated with the vehicle to help detect sudden impact forces or collisions. Once such an impact is detected (via the sensors/accelerometers), the system activates the electromagnets to initiate the reverse polarity response.

As described in detail throughout this Detailed Description, and without being bound by theory, in additional embodiments of the present technology the disclosed anti-collision features may also be configured to interfere with a vehicle on the verge of colliding with another vehicle or a stationary obstacle on the road, e.g., to reduce the likelihood of a collision, or reduce the impact of an unpreventable collision.

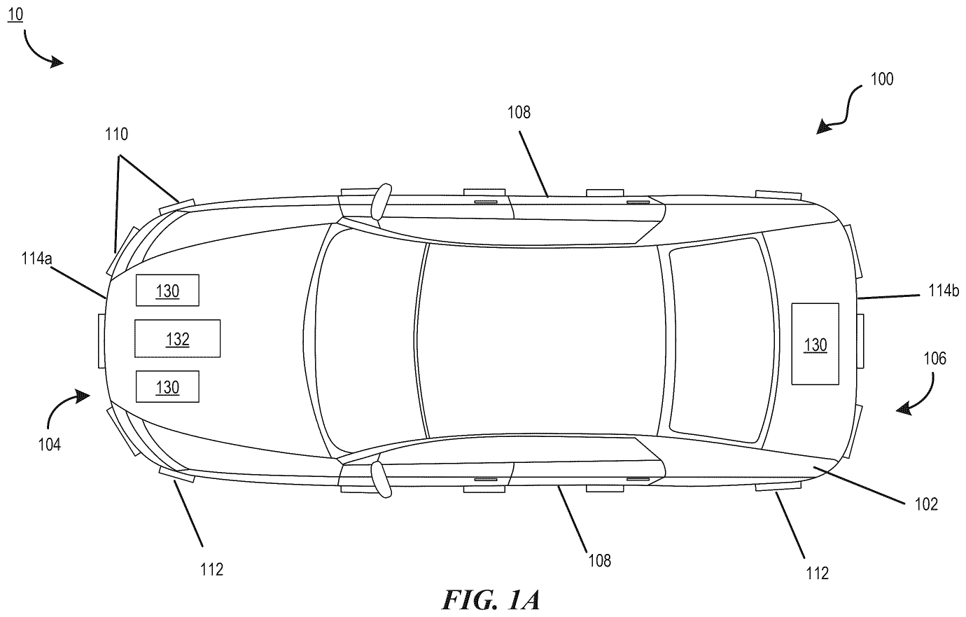

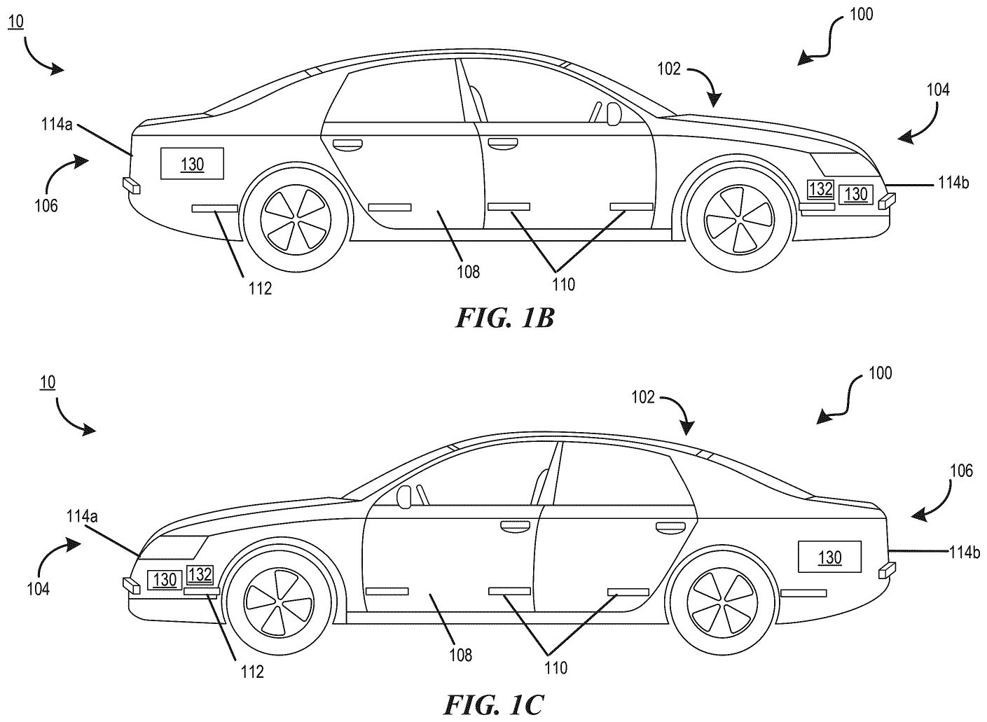

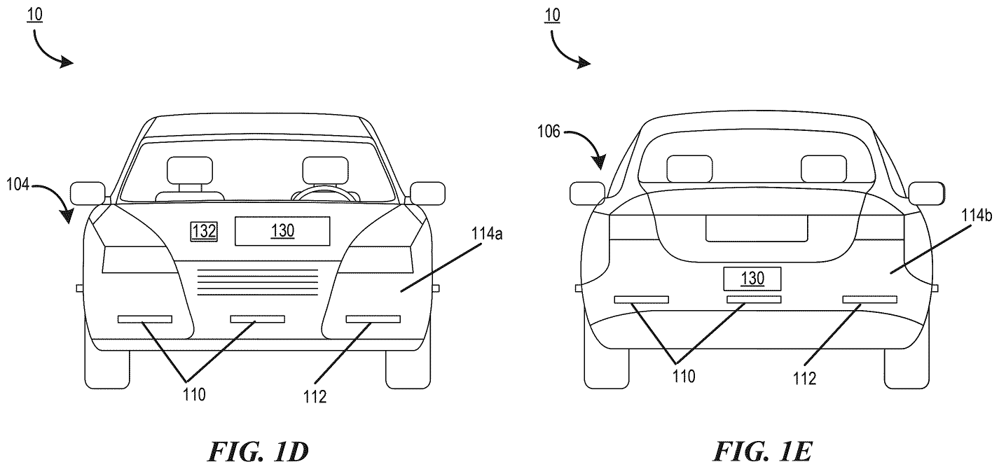

The terminology used in the description presented below is intended to be interpreted in its broadest reasonable manner, even though it is being used in conjunction with a detailed description of certain specific embodiments of the present technology. Certain terms may even be emphasized below; however, any terminology intended to be interpreted in any restricted manner will be overtly and specifically defined as such in this Detailed Description section. Additionally, the present technology can include other embodiments that are within the scope of the claims, but are not described in detail with respect to FIG. 1A-5E.

Reference throughout this specification to “one embodiment” or “an embodiment” means that a particular feature, structure, or characteristic described in connection with the embodiment is included in at least one embodiment of the present technology. Thus, the appearances of the phrases “in one embodiment” or “in an embodiment” in various places throughout this specification are not necessarily all referring to the same embodiment. Furthermore, the particular features or characteristics may be combined in any suitable manner in one or more embodiments.

As used herein, the use of relative terminology, such as “about,” “approximately,” “substantially,” and the like refer to the stated value plus or minus ten percent. In instances in which the context requires otherwise and/or relative terminology is used in reference to something that does not include a numerical value, the terms are given their ordinary meaning to one skilled in the art.

The headings below are provided by way of convenience only and are not to be used to interpret the scope of the claimed technology.

### A. Select Embodiments of Magnetic Repulsion Systems

FIG. 1A-1E are top and side views of a vehicle 10 including a magnetic repulsion system 100 (“the system 100”) configured in accordance with an embodiment of the present technology. As described in greater detail below, the system 100 comprises a plurality of magnetic components (e.g., magnetic bars) 110 configured to generate a magnetic force that repels corresponding magnetic forces from another proximate vehicle or object to inhibit or reduce the severity of a collision between two (or more) vehicles or the object(s).

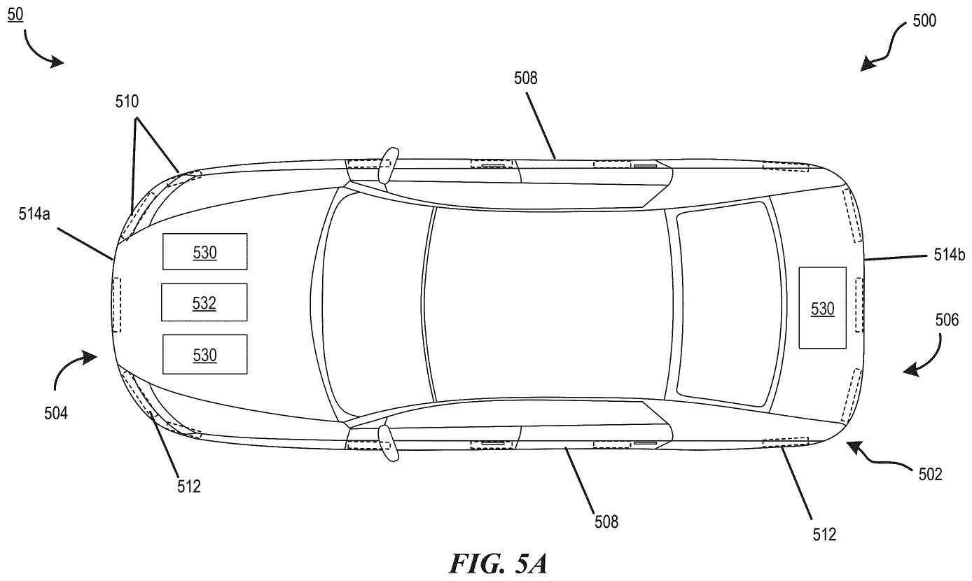

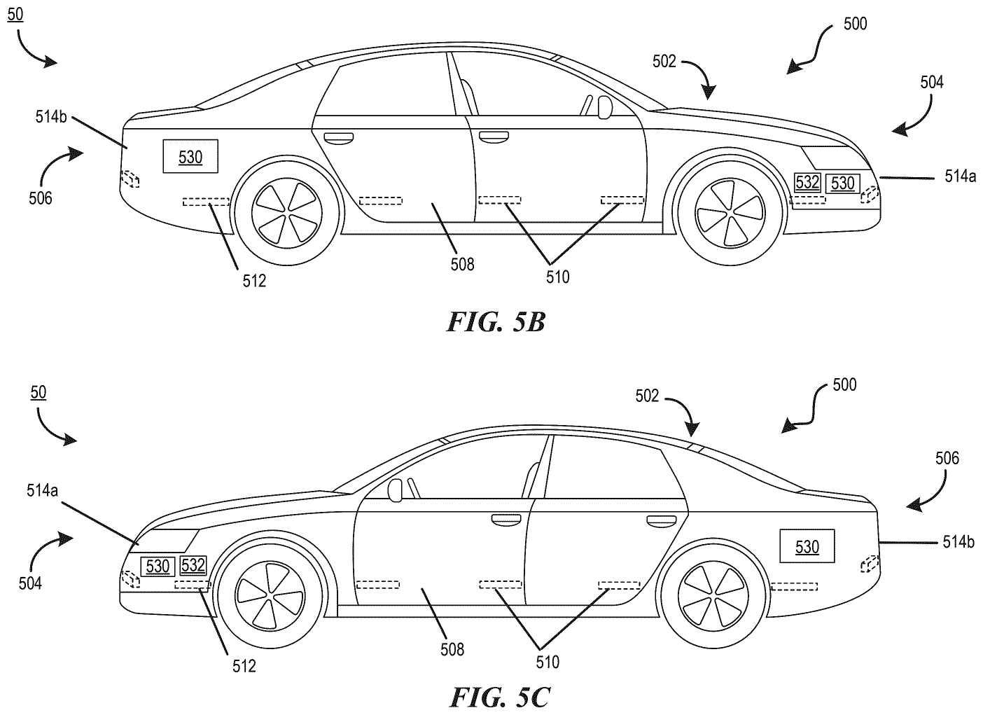

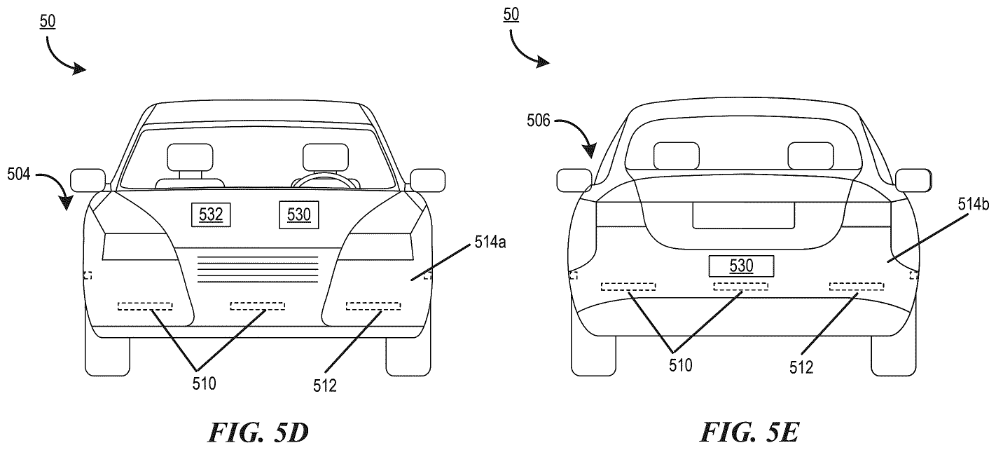

Referring first to FIG. 1A, the vehicle 10 includes a body 102, a front portion 104, a back portion 106, and a pair of lateral sides 108 (“the lateral sides 108”). The vehicle 10 also includes a front bumper 114a at the front portion 104 of the vehicle 10, and a rear bumper 114b at the back portion 106 of the vehicle 10. The bumpers 114a-b and lateral sides 108 of the vehicle 10 have exposed outer surfaces. As noted previously, the system 100 includes magnetic bars 110 positioned at select locations about the vehicle 10. Referring to FIG. 1B-1E of the illustrated embodiment, for example, system 100 includes magnetic bars 110 positioned at the front portion 104, back portion 106, and lateral sides 108 of the vehicle 10. In some embodiments, the magnetic bars 110 are operably coupled (e.g., screws, adhesive, fasteners, etc.) to an exterior surface of the vehicle 10. In other embodiments, however (such as those described below with reference to FIG. 5A-5E), the magnetic bars 110 may be partially or fully built-in/integral with the different portions of the vehicle 10 (e.g., the bumpers 114, the doors, etc.).

The magnetic bars 110 can be electromagnets that rely on an electric current to generate a magnetic field. In such embodiments, the magnetic bars 110 can include a coil and input to a current source. With the plurality of magnetic bars 110, the polarity is reversed by changing the direction of the current flow through the coil, where the resulting magnetic field also changes direction, effectively reversing the polarity of the corresponding magnet. In some embodiments, each magnetic bar 110 can be composed of a ferromagnetic metal (e.g., nickel, iron, cobalt, etc.), or the like. Further, the magnetic bars 110 can be rigid, rectangular, and discretized, such that the user may choose whether to place the bars 110 on only the bumpers 114a-b, or only on the lateral sides 108. In some embodiments, the magnetic bars 110 can be composed of a flexible material (e.g., a combination of rubber polymer resin and ferrite powder) and wrap around the body 102.

As illustrated in FIG. 1A-1E, in some embodiments, the exposed surfaces of the magnetic bars 110 throughout the vehicle 10 have the same polarity (e.g., North Pole or South Pole). Moreover, in some embodiments, each vehicle including the system 100 can have the same polarity. For instance, if the magnetized bars 110 on a first vehicle are of North polarity, then the magnetized bars 110 on a second vehicle are also of North polarity. Without intending to be bound by theory, the polarity of each magnetized bar 110 can be reversed during operation. For example, the system 100 can also include sensor(s) and/or accelerometer(s) 130 (shown schematically) integrated with the vehicle 10. The sensors/accelerometers 130 can be configured to continuously monitor movement/acceleration data of the vehicle 10 and detect sudden impact forces or collisions (e.g., when a measured acceleration magnitude exceeds a threshold value). Once such an impact is detected (via the sensors/accelerometers 130), the system 100 activates an electromagnetic module 132 (shown schematically) to help modulate the magnetic bars 110 (e.g., electromagnets) to initiate the reverse polarity response. It is expected that designing the polarity of the magnetic bars 110 such that they can be reversed upon a collision will simplify the manufacturing process, as it may be simpler and/or cheaper to manufacture each magnetic bar 110 as a traditional magnet instead of attempting to create a universal bar across different vehicle manufacturers.

A person skilled in the art will appreciate that the system 100 is just one example of a magnetic repulsion system implemented on the vehicle 10 where magnetized bars 110 can be operably coupled to various locations (e.g., bumpers 114a-b, lateral sides 108) of the body 102 of the vehicle 10 and configured to be initiated/activated via the above-described reverse polarity response. FIG. 1A-1E describe various examples implementing a magnetic repulsion system on vehicle 10 through the placement of the bars 110 along the bumpers 114a-b, lateral sides 108, and/or other positions on the body 102 of the vehicle 10. However, the present technology is not limited to such implementations expressly shown herein—in some embodiments, the positions, shapes, and/or sizes of each magnetic bar 110carried by the vehicle 10 can differ beyond those expressly shown herein.

### B. Select Embodiments of Anti-Collision Mechanisms, for Use With Magnetic Repulsion Systems

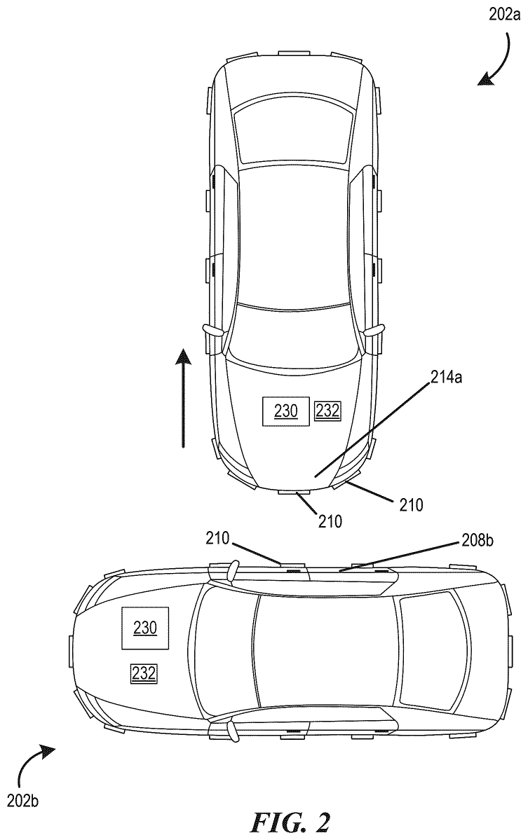

FIG. 2-4 illustrate examples of collisions between two vehicles 202 (identified as a first vehicle 202a and a second vehicle 202b). The vehicles include magnetic repulsion systems configured in accordance with the present technology to reduce or mitigate the severity of the collision. In particular, upon collision, the magnetic bar(s) 210 carried by one vehicle 202a will repel corresponding magnetic bar(s) 210 carried by the other vehicle 202b.

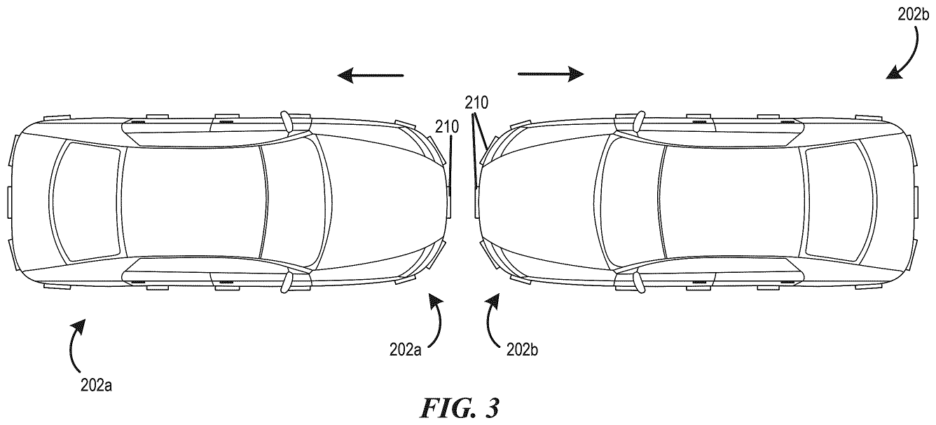

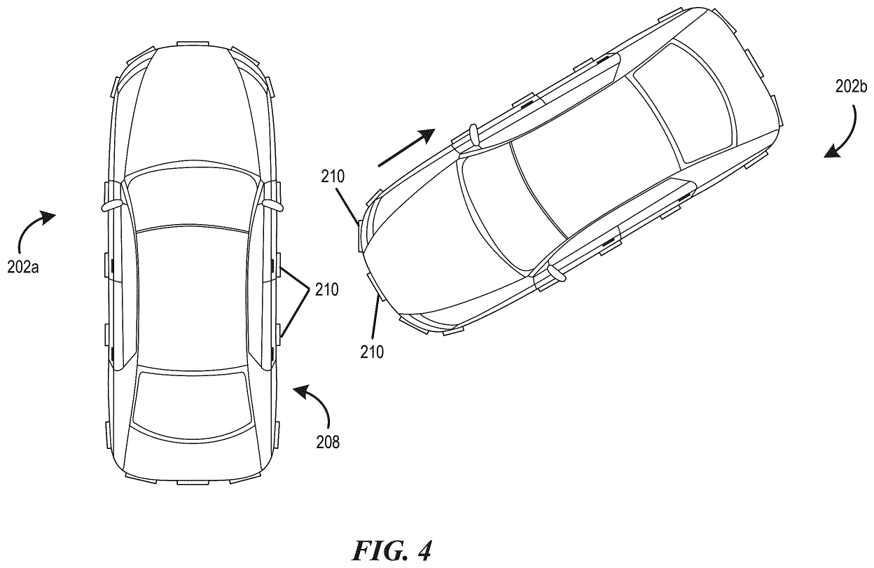

For example, in FIG. 2, as vehicle 202a collides with vehicle 202b, sensors and/or accelerometers 230 carried by the vehicles 202a-b detect the sudden impact forces/collision, and an electromagnetic module 132 (shown schematically) is activated to help modulate the magnetic bars 210 and quickly change the magnetic field orientation of the magnetic bars 210 carried by a front portion 214a of vehicle 202a such that they will repel magnetic bar(s) 210 carried by a lateral side 208b of the vehicle 202b. In some embodiments, upon inadvertent contact between one or more vehicles that include systems configured in accordance with the disclosed technology, the respective systems will confirm that the corresponding magnetic bar(s) carried by the individual vehicles are opposite poles—and accordingly repel each other. This is expected to inhibit/diminish the severity of the collision between the vehicles, and is further expected to minimize/prevent injuries and/or damage to the vehicles. FIGS. 3 and 4 illustrate additional examples of inadvertent contact between vehicles 202a and 202b in which the magnetic repulsion systems are expected to inhibit/diminish the severity of such collisions.

As one skilled in the art will appreciate, the orientation of vehicle 202a and vehicle 202b colliding can include a variety of different arrangements beyond those shown in FIG. 2-4. For example, vehicle 202a can rear-end vehicle 202b or engage/contact vehicle 202b in a variety of other orientations.

### C. Select Embodiments of Internalized Magnets for Use With Magnetic Repulsion Systems

FIG. 5A-5E are top and side views, respectively, of a vehicle 50 including a magnetic repulsion system 500 (“the system 500”) configured in accordance with an embodiment of the present technology. As described in greater detail below, the system 500 is fitted with a plurality of internalized magnetic bars 510 that are each configured to generate magnetic force that repels corresponding magnetic forces from another vehicle to inhibit or reduce the severity of a collision between the two (or more) vehicles.

The magnetic repulsion system 500 of vehicle 50 includes components and features generally similar to the system 100 illustrated in FIG. 1A-1E, and similar components are labeled with similar reference numbers. Accordingly, the discussion of these similar components is omitted here.

Referring first to FIG. 5A, the vehicle 50 includes a body 502, a front portion 504, a back portion 506, and a pair of lateral sides 508 (“the lateral sides 508”). The vehicle 50 also includes a front bumper 514a at the front portion 504 of the vehicle 50, and a rear bumper 514b at the back portion 506 of the vehicle 50. As noted previously, the system 500 includes internalized magnetic bars 510 positioned at select locations about the vehicle 50. Referring to FIG. 5B-5E of the illustrated embodiment, for example, system 500 includes internalized magnetic bars 510 within body 502 at the front portion 504, the back portion 506, and both lateral sides 508 of the vehicle 50. As illustrated in FIG. 5A-5E, for example, the internalized magnetic bars 510 extend along the perimeter of the bumpers 514a-b and the lateral sides 508 around the entire vehicle 50. In some embodiments, the internalized magnetic bars 510 are coupled (e.g., via welding, screws, adhesive, fasteners, etc.) to non-exposed inner surfaces of the vehicle 50.

The magnetic bars 510 can be electromagnets similar to the magnetic bars 110 described above with reference to FIG. 1A-1E, and can be operably coupled to sensor(s)/accelerometer(s) 530 (shown schematically) and an electromagnetic module 532 (shown schematically) to help modulate the magnetic bars 510 during operation and initiate the reverse polarity response once an impact/collision is detected. The magnetic bars 510 may be composed of similar materials to those described above with respect to magnetic bars 110 (e.g., ferromagnetic metals such as nickel, iron, cobalt, or the like). Further, the internalized magnetic bars 510 can be discrete, individual, rigid, rectangular components. In other embodiments, however, the internalized magnetic bars 510 can be composed of a flexible material (e.g., a combination of rubber polymer resin and ferrite powder) and wrap around the non-exposed interior surface of the body 502. The magnetic bars 510 can also be electromagnets.

A person skilled in the art will appreciate that the system 500 is just one example of a magnetic repulsion system implemented on a vehicle 50, where internalized magnetic bars 510 can be carried at various internal locations (e.g., bumpers 514a-b, lateral sides 508) about the vehicle 50. However, the present technology is not limited to such implementations expressly shown herein—in some embodiments, the positions, shapes, and/or sizes of each magnetic bar 510 carried by the body 502 of the vehicle 50 can differ beyond those expressly illustrated herein.

Although the steps of the methods described herein are discussed and/or illustrated in a particular order, the methods described herein are not so limited. In other embodiments, the methods described herein can be performed in different orders. In these and other embodiments, any of the steps of the methods described herein can be performed before, during, and/or after any of the other steps of the methods described herein. Furthermore, a person skilled in the art will readily recognize that the methods described herein can be altered and still remain within these and other embodiments of the present technology. For example, one or more steps of the methods described herein can be omitted and/or repeated in some embodiments.

Although not shown so as to avoid unnecessarily obscuring the description of the embodiments of the technology, any of the forgoing systems and methods described above can include and/or be performed by a computing device configured to analyze and operate magnetic components of the systems and/or to receive, arrange, store, analyze, and/or otherwise process data received, for example, from the sensors, accelerometers, magnetic components, and/or other components of the systems. As such, such a computing device includes the necessary hardware and corresponding computer-executable instructions to perform these tasks. More specifically, a computing device configured in accordance with an embodiment of the present technology can include a processor, a storage device, input/output device, one or more sensors, and/or any other suitable subsystems and/or components (e.g., displays, speakers, communication modules, etc.). The storage device can include a set of circuits or a network of storage components configured to retain information and provide access to the retained information. For example, the storage device can include volatile and/or non-volatile memory. As a more specific example, the storage device can include random access memory (RAM), magnetic disks or tapes, and/or flash memory.

The computing device can also include (e.g., non-transitory) computer-readable media (e.g., the storage device, disk drives, and/or other storage media) including computer-executable instructions stored thereon that, when executed by the processor and/or computing device, cause the systems to perform one or more of the methods described herein. Moreover, the processor can be configured to perform or otherwise control steps, calculations, analysis, and any other functions associated with the methods described herein.

In some embodiments, the storage device can store one or more databases used to store data collected by the systems, as well as data used to direct and/or dynamically adjust components of the systems. In one embodiment, for example, a database is an HTML file designed by the assignee of the present disclosure. In other embodiments, however, data is stored in other types of databases or data files.

In some embodiments, the computing devices and systems on which the system can be implemented can include a central processing unit, input devices, output devices (e.g., display devices and speakers), storage devices (e.g., memory and disk drives), network interfaces, graphics processing units, accelerometers, cellular radio link interfaces, global positioning system devices, and/or the like. The input devices can include keyboards, pointing devices, touchscreens, gesture recognition devices (e.g., for air gestures), thermostats, smart devices, head and eye tracking devices, microphones for voice or speech recognition, and/or the like. The computing devices and systems can include desktop computers, laptops, tablets, e-readers, personal digital assistants, smartphones, gaming devices, servers, and computer systems such as massively parallel systems. The computing devices and systems can each act as a server or client to other server or client devices. The computing devices and systems can access computer-readable media that include computer-readable storage media and data transmission media. The computer-readable storage media are tangible storage means that do not include transitory, propagating signals. Examples of computer-readable storage media include memory such as primary memory, cache memory, and secondary memory (e.g., CD, DVD, Blu-Ray), and include other storage means. Moreover, data may be stored in any of a number of data structures and data stores, such as databases, files, lists, emails, distributed data stores, storage clouds, and/or the like.

The computer-readable storage media can be recorded upon or encoded with computer-executable instructions or logic that implements the system, such as a component comprising computer-executable instructions stored in one or more memories for execution by one or more processors. In addition, the stored information can be encrypted. The data transmission media are used for transmitting data via transitory, propagating signals or carrier waves (e.g., electromagnetism) via a wired or wireless connection. In addition, the transmitted information can be encrypted. Various communications links can be used, such as the Internet, a local area network, a wide area network, a point-to-point dial-up connection, a cell phone network, and/or the like for connecting the computing systems and devices to other computing systems and devices to send and/or receive data, such as via the Internet or another network and its networking hardware, such as switches, routers, repeaters, electrical cables and optical fibers, light emitters and receivers, radio transmitters and receivers, and/or the like. While computing systems and devices configured as described above are typically used to support the operation of the system, those skilled in the art will appreciate that the system can be implemented using devices of various types and configurations, and having various components.

One of ordinary skill in the art will understand that various components of the systems (e.g., the computing device) can be further divided into subcomponents, or that various components and functions of the systems may be combined and integrated. In addition, these components can communicate via wired and/or wireless communication, as well as by information contained in the storage media.

### Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while each of the examples provided herein are directed to motor vehicles, the disclosed technology may also be utilized with other types of vehicles, boats, trains, etc. Further, the disclosed technology may also be implemented into stationary structures that associated with or around motor vehicles, such as traffic barriers, barricades, loading docks, and the like. While steps are presented in a given order, alternative embodiments may perform steps in a different order. Moreover, the various embodiments described herein may also be combined to provide further embodiments. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment.

For ease of reference, identical reference numbers are used to identify similar or analogous components or features throughout this disclosure, but the use of the same reference number does not imply that the features should be construed to be identical. Indeed, in many examples described herein, identically numbered features have a plurality of embodiments that are distinct in structure and/or function from each other. Furthermore, the same shading may be used to indicate materials in cross-section that can be compositionally similar, but the use of the same shading does not imply that the materials should be construed to be identical unless specifically noted herein.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Where the context permits, singular or plural terms may also include the plural or singular term, respectively. Additionally, the term “comprising” is used throughout to mean including at least the recited feature(s) such that any greater number of the same feature and/or additional types of other features are not precluded. Directional terms, such as “upper,” “lower,” “front,” “back,” “vertical,” and “horizontal,” may be used herein to express and clarify the relationship between various elements. It should be understood that such terms do not denote absolute orientation. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A magnetic repulsion system for mitigating a collision between moving vehicles, the magnetic repulsion system comprising:
a plurality of first magnetic bars carried by a first vehicle, wherein the magnetic bars are positioned at a front portion, a back portion, and along lateral side portions of the first vehicle, and wherein the first magnetic bars have a first polarity; and
an electromagnetic module carried by the first vehicle and operably coupled to the first magnetic bars,
wherein, upon inadvertent contact between the first vehicle and a second vehicle carrying a plurality of second magnetic bars having a second polarity, the electromagnetic module is configured to modulate the first polarity such that it is opposite to the second polarity and the second magnetic bars are repelled by the first magnetic bars, thereby inhibiting severity of the contact between the first and second vehicles.

2. The magnetic repulsion system of claim 1 wherein the plurality of first magnetic bars are positioned on an external surface of the first vehicle.

3. The magnetic repulsion system of claim 2 wherein the plurality of first magnetic bars are operably coupled to the external surface of the first vehicle via a plurality of fasteners, a plurality of screws, adhesive, or any combination thereof.

4. The magnetic repulsion system of claim 1 wherein the plurality of first magnetic bars are carried at various internal locations about the first vehicle.

5. The magnetic repulsion system of claim 1 wherein the plurality of first magnetic bars are distributed about an entire perimeter of the first vehicle.

6. The magnetic repulsion system of claim 1 wherein the plurality of second magnetic bars are distributed about an entire perimeter of the second vehicle.

7. The magnetic repulsion system of claim 1 wherein the plurality of first magnetic bars and the plurality of second magnetic bars are composed of ferromagnetic metal.

8. The magnetic repulsion system of claim 1 wherein the plurality of first magnetic bars and the plurality of second magnetic bars are composed of a flexible material including rubber polymer resin and ferrite powder.

9. The magnetic repulsion system of claim 1 wherein the plurality of first magnetic bars and the plurality of second magnetic bars are electromagnets.

10. The magnetic repulsion system of claim 1 wherein:
the plurality of first magnetic bars can change polarity at or immediately before inadvertent contact with the second vehicle; and
the plurality of second magnetic bars can change polarity such that second magnetic bars repel the first magnetic bars at or immediately before inadvertent contact with the first vehicle.

11. A vehicle system, comprising:
an electromagnetic module carried by a first vehicle; and
first magnetic components positioned about an external perimeter of the first vehicle and operably coupled to the electromagnetic module, wherein the first magnetic components have a first polarity,
wherein, upon an inadvertent collision between the first vehicle and a second object carrying second magnetic components having a second polarity, the electromagnetic module is configured to modulate the first polarity such that it is opposite to the second polarity and the first magnetic components are repelled by the second magnetic components, thereby inhibiting severity of contact between the first vehicle and the second object.

12. The vehicle system of claim 11 wherein the first vehicle comprises:
a motor vehicle;
a boat; or
a train.

13. The vehicle system of claim 11 wherein the second object comprises:
a motor vehicle;
a boat;
a train;
a barrier; or
a blockade.

14. The vehicle system of claim 11 wherein the first magnetic components are positioned on an external surface of the first vehicle.

15. The vehicle system of claim 11 wherein the first magnetic components are operable installed within internal locations about the first vehicle.

16. The vehicle system of claim 11 wherein the first magnetic components are distributed about an entire perimeter of the first vehicle.

17. The vehicle system of claim 11 wherein the second magnetic components are distributed about an entire perimeter of the second object.

18. The vehicle system of claim 11 wherein the first magnetic components and the second magnetic components are composed of ferromagnetic metal.

19. The vehicle system of claim 11 wherein the first magnetic components and the second magnetic components are composed of electromagnets.

20. The vehicle system of claim 11 wherein:
the first magnetic components are configured to change polarity at or immediately before the inadvertent collision with the second object; and
the second magnetic components are configured to change polarity such that second magnetic components repel the first magnetic components at or immediately before the inadvertent collision with the first vehicle.
